(19) United States
(12) Patent Application Publication
(10) Pub. No.: US 2015/0083201 A1
(43) Pub. Date: Mar. 26, 2015

(54) HYBRID SOLAR CELL

(71) Applicant: COMPAS INDUSTRIES LLC, Wakefield, MA (US)

(72) Inventor: Helen E. VanBenschoten, Wakefield, MA (US)

(21) Appl. No.: 14/498,361

(22) Filed: Sep. 26, 2014

Related U.S. Application Data
(60) Provisional application No. 61/882,654, filed on Sep. 26, 2013.

(51) Int. Cl. H01G 9/20

(52) U.S. Cl. CPC H01G 9/2031; H01G 9/2036
USPC 136/254; 438/98

(57) ABSTRACT

Methods and devices are disclosed herein that generally involve solar cells having an anode formed in a core/shell/shell construction. The core is formed from oxide nanoparticles, which are then coated with a catalyst and a photoactive semiconductor. This construction, which can be combined with other innovations described herein, results in an inexpensive but efficient solar cell.

### CROSS-REFERENCE TO RELATED APPLICATIONS

This application claims the benefit of U.S. provisional patent application No. 61/882,654 filed Sep. 26, 2013, which application is hereby incorporated by reference in its entirety.

### FIELD

The embodiments disclosed generally relate to the field of solar cells, specifically methods of preparation, and the composition of photoelectrochemical cells.

### BACKGROUND

Silicon solar technologies are rapidly maturing, dropping in price from over $7 W peak installed to less than $4 between 2008 and 2012, and are projected to drop to below $2 W peak installed by 2020. This is primarily due to mass production of thin film solar panels by Chinese manufacturers (1). Because of China's market dominance, concerns that today's low costs might not be sustainable (2), and dropping cost of competitive energy technologies (such as natural gas produced by fracking), there is incentive to explore alternate chemistries that could reduce the cost of solar energy even further.

Fourth generation solar technologies have focused on reducing material and processing costs while maintaining competitive efficiencies. Many of these technologies utilize nanotechnology, and as such higher active areas enhance light harvesting, enabling power production in low light. Such technologies include dye-sensitized solar cells (DSSC), Organic photovoltaic cells (OPV) and hybrid (organic/inorganic) solar cell technologies. The invention described here falls in the latter category. It aims to reduce material and processing costs, and unlike its competition, aims to use environmentally benign materials and processes to enhance the product's societal benefit.

Solar cells must contain photosensitive material(s), which is typically a semiconductor that absorbs visible light. Upon light absorption, electron-hole pairs are created. Charge separation creates a potential within a solar device-this is typically accomplished using a p-n junction, or in the case of photoelectrochemical cells such as the invention, a cathode, anode and electrolyte such as found in an electrochemical cell.

Commercial solar cells contain p-n junctions and are typically made from dense semiconductors, which are doped, necessitating expensive, energy or solvent intensive processes in order to produce high purity materials. The photoelectrochemical cells of fourth generation solar technologies typically use porous high surface area electrode materials, which do not require ultra high purity, but development of high efficiency sensitizers, electrolytes, and current collectors has been slow. Back electron transfer, which dramatically limits efficiency, is a problem for many sensitizer/electrolyte systems. Another issue has been the loss of efficiency due to kinetic limitations in larger form factor cells, and drops in efficiency due to scale up (typically roll to roll). The major issue limiting commercial adoption of fourth generation solar technologies has been the short lifetime due to degradation of components. Electrolytes have typically been corrosive liquids, which leach active components, and degradable organic sensitizers. The invention here aims to resolve these problems through its use of novel processes and stable components. The following sections will give background of the key components.

Dye sensitized solar cells (DSSC) involve the adsorption of organic dye on titanium dioxide (TiO2) or zinc oxide (ZnO) to adsorb a broad spectrum of light and create electron donor levels (14,15,16). Patents in this area include U.S. Pat. No. 4,927,721 A, U.S. Pat. No. 5,084,365 A, U.S. Pat. No. 6,024,807 A, U.S. Pat. No. 8,586,861 B2, WO2012120283A3. Alternate oxides have been cited for their use in DSSC in WO 2011103503 A1 (on which the current inventor is a co-inventor). In recent years cobalt-based electrolytes, and lead-based perovskite sensitizers have become the dominant materials (US20140060612).

Organic Photovoltaics (OPV) utilize organic photosensitizers and conductive layers, and Eastman's Kodack's work in this area precedes DSSC by more than a decade: U.S. Pat. No. 4,164,431 A, U.S. Pat. No. 4,356,429. Researchers have continued to pursue organic photovoltaics because of the potential for very low cost flexible solar energy, but low efficiencies are an issue.

Hybrid solar cells combine elements of both inorganic and organic solar cells. US 20070295389 A1 discloses hybrid solar cells, but this disclosure lacks key elements necessary for practical use of the technology. Other patents for hybrid solar cells include U.S. Pat. No. 7,705,523 B2. The solar cells produced by Oxford PV can be considered hybrid cells, as they use polymeric electrolytes with perovskite (or other metal oxide) sensitizers and conductive glass (Prof. Henry Snaith of ISIS, WO 2010142947 A1).

Oxide semiconductors have long been used in solar cells, and one of the earliest solar cells was a copper/cuprous oxide (Cu/CuO). Although solar energy research has been dominated by non-oxide semiconductors, oxides are still attractive because of their low cost, but efficiencies have been low. TiO₂ or ZnO have been combined with cupric oxide (Cu₂O) in heterojunction solar cells for years (10,11,18). The theoretical efficiency of Cu₂O solar cells is 20% (12) but defects in Cu₂O have limited efficiencies to below 2% (13). There are a number of patents for Cu₂O based solar cells but none of these technologies has been commercialized: U.S. Pat. No. 6,849,798 B2, WO 2013124134 A1.

In US 20070095390 A1 Samsung discloses a solar cell which can be made using n and p type semiconducting oxide nanoparticles joined by necks. It appears to have not been commercialized. LaVO₃ grown on SrTiO₃ or LaFeO₃ creates suitable bandgap and absorption spectra for solar cells (17). Patents for doped oxide solar cells include: U.S. Pat. No. 6,998,288 B1, which discloses a doped silicon oxide solar cell. Other recent work involving semiconductors as sensitizers include CuSCN on TiO₂+CdS at Weizmann Institute of Science in Israel (3) and CdS and PbS quantum dots, researched by various institutions (4-6).

Catalysts are used to enhance kinetics of chemical reaction, and are typically present on the cathode of photoelectrochemical cells. Use of a platinum catalyst in a DSSC was cited by Samsung in U.S. Pat. No. 7,767,618 B2. Samsung's processing method uses polymer micelle, and the amount of platinum catalyst was significantly greater than in the invention cited here, presumably reducing the economic viability of the invention.

There are many processes used to fix precious metals and semiconductors to oxides. Impregnation processes followed by dry thermal decomposition are widely used but do not result in fine nanoparticle coatings: U.S. Pat. No. 3,893,950 A, (7). Methods which produce nanoparticles typically involve polymeric micelles or reverse micelles WO 2008146823 A2, (8), although a similar process to the invention was reported after the filing of 61/882,654 (9).

There still exists a need for low cost, high efficiency, easy to manufacture solar cells using oxide nanoparticles.

### SUMMARY

Methods and devices are disclosed herein that generally involve solar cells having an anode formed in a core/shell/shell construction. The core is formed from oxide nanoparticles, which are then coated with a catalyst and a photoactive semiconductor. This construction, which can be combined with other innovations described herein, results in an inexpensive but efficient solar cell.

In one aspect, a solar cell is provided having a substrate, a transparent barrier film, an anode disposed between the substrate and the transparent barrier film, and a cathode. The anode includes a film of oxide nanoparticles having first and second coating layers. One of the first and second coating layers is a catalyst nanoparticle coating layer and a second one of the first and second coating layers is a metal oxide photoactive semiconductor coating layer.

In specific embodiments, the substrate comprises an aluminum alloy that forms part of the anode.

In other embodiments, the film of oxide nanoparticles is formed of titanium oxide. The metal oxide photoactive semiconductor coating layer can be formed from a material having have a conduction band edge below −4.21 eV and a band energy gap less than 2 eV. The metal oxide photoactive semiconductor coating layer can further be formed from cupric oxide. The metal oxide photoactive semiconductor coating layer can also be formed from hematite.

In certain embodiments, the catalyst nanoparticle coating layer can be formed from platinum. The catalyst nanoparticle coating layer could also be formed from palladium.

In further embodiments, the transparent barrier film is conductive and forms the cathode. The transparent barrier film the barrier film can further be a three layer transparent conductive barrier film comprising a catalyst layer which acts as a cathode, a transparent conducting oxide, which acts as part of the cathode, and a transparent barrier film layer. The solar cell can further comprising an electrolyte provided between the anode and the cathode.

### BRIEF DESCRIPTION OF THE DRAWINGS

The invention will be more fully understood from the following detailed description taken in conjunction with the accompanying drawings, in which:

FIG. 1 is a schematic view of a solar cell of the invention;

FIGS. 2A-E illustrates a method of making an embodiment of the invention.

### DETAILED DESCRIPTION

Methods and devices are disclosed herein that relate generally to solar cells and their manufacture. The present inventor considers the disclosure herein to relate to a hybrid solar cell. The solar cells can include an aluminum substrate as a current collector, combined with oxide semiconductors in a core/shell/shell nanocomposite as an electrode, and a catalyst for electron transfer kinetics. This construction allows for efficient solar cells to be readily manufactured using inexpensive materials.

Certain exemplary embodiments will now be described to provide an overall understanding of the principles of the structure, function, manufacture, and use of the methods and devices disclosed herein. One or more examples of these embodiments are illustrated in the accompanying drawings. Those skilled in the art will understand that the methods and devices specifically described herein and illustrated in the accompanying drawings are non-limiting exemplary embodiments and that the scope of the present invention is defined solely by the claims. The features illustrated or described in connection with one exemplary embodiment can be combined with the features of other embodiments. Such modifications and variations are intended to be included within the scope of the present invention.

The present inventors believe that, while not intending to limit the invention in any manner, photosensitive oxides can be improved for use as a substitute or replacement for dye as used in the solar cells described above. Innovations that aid in this improvement include a core/shell/shell structure for the oxide as will be discussed below, and the inclusion of a catalyst in that structure to improve the electron transfer kinetics for the oxide material. An aluminum substrate can also be employed with the oxide materials as a current collector.

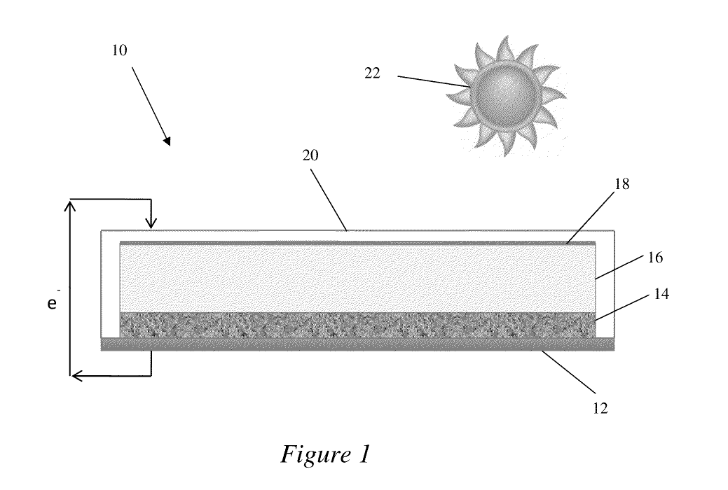

The structure of a solar cell of the invention can be described by reference to FIG. 1. The solar cell 10 of FIG. 1 includes an inferior substrate 12, an oxide material 14, an electrolyte 16, and a transparent barrier film 18.

Substrate 12 can be an aluminum alloy. The aluminum alloy 12 acts as a substrate for the cell and as at least a part of the cell's first electrode. In the described embodiment, the aluminum alloy acts as a part of the cell's anode, although the cell could also be arranged so that the aluminum alloy could form part of the cell's cathode. Commercial aluminum alloys offer good resistance to oxidation, nominal mechanical strength, and low cost. Consumer grade aluminum foil (8111), and commercial industrial foil (3105) have been used in prototype cells, and may be used for flexible cell applications.

The oxide material 14 can form at least part of the anode. In one embodiment, the oxide material 14 is provided as a thin film of titanium oxide nanoparticles. The film can be composed of Degussa/Evonic P25, but other compositions can be used as well.

The oxide nanoparticles are coated with a catalyst. In one embodiment, the catalyst can be platinum. In other embodiments, the catalyst can be palladium or other catalyst materials. The nanoparticles can be coated with a low concentration (for example, less than 1 percent by weight) of the catalyst such that the catalyst crystals exist on the oxide nanoparticles as fine nanoparticles. In this embodiment, the catalyst provides a non-continuous layer over the oxide. The catalyst layer acts as a catalyst for electron transfer.

A third component, which is a photoactive semiconductor, is coated onto the oxide nanoparticles. This semiconductor may be composed of single, binary or ternary metal oxides including but not limited to vanadium pentoxide (V₂O₅), tin dioxide (SnO₂), Lead hexaferrite (PbFe₁₂O₁₉), Nickel titanate (NiTiO₃), hematite (Fe₂O₃), cuprous oxide (CuO) and/or silver oxide (Ag₂O). The semiconductor material should (1) be photoactive, having a high quantum yield, (2) have a conduction band edge just below that of the oxide material (for TiO₂, CBE=−4.21 eV) and (3) have a band energy gap less than 2 eV. The semiconductor may be either the outer layer or the middle layer of the core/shell/shell structure.

The solar cell 10 also includes a transparent barrier film 18 on its superior side that admits light from sun 22. Where the barrier film is used as at least part of an electrode, the barrier film may be conductive. In the illustrated embodiment, the barrier film is conductive and forms a cathode. In other embodiments, the anode could be provided on the barrier film, and the barrier film may or may not form part of the anode while the inferior substrate forms the cathode. In a preferred embodiment, the barrier film is a three layer transparent conductive barrier film comprising (1) a catalyst layer, which acts as a cathode, (2) a transparent conducting oxide, which acts as part of the cathode, and (3) a transparent barrier film such as PEN or PET, which protects the cell from mechanical and chemical degradation. Commercially available transparent conducting films may be used. A sealant film 20 can also be applied to encapsulate the entire device.

In one embodiment, the cathode and anode may be separated by an electrolyte 16. The electrolyte can be a solid electrolyte which may be one of the following:

1. A conductive polymer such at Spiro-OMeTad, which might be doped with an ionic species;

2. A conductive glass such as a chalcogenide, which has been doped; or

3. A composite of glass or polymer, semiconductor (such as graphite, carbon nanotubes) or metal nanoparticles, and an ionic species.

The solid electrolyte must conduct an ionic species, which is efficiently reduced at the cathode and oxidized at the anode.

The invention also includes methods for making the solar cell described above, and, in particular, for making the core/shell/shell structure used as an electrode in the solar cell. A method for forming an electrode having a core and two layers for use in a solar cell can start with a titanium or other oxide nanoparticle substrate. The two layers, a catalyst layer and the metal oxide photo active semiconductor layer can be added in any order onto the titanium oxide nanoparticle substrate. The catalyst layer can be added by (1) impregnating a metal salt onto the titanium oxide nanoparticle substrate in an aqueous or alcohol solvent; (2) fixing the metal salt to the surface of the titanium oxide nanoparticle substrate by heating; and (3) chemically reducing the metal salt to a desired metal or metal oxide. The photoactive metal oxide layer can be added by (1) impregnating a metal salt onto the titanium oxide nanoparticle substrate in an aqueous or alcohol solvent; (2) fixing the metal salt to the surface of the titanium oxide nanoparticle substrate by heating; and (3) chemically reducing the metal salt to a desired metal oxide. Specific manufacturing examples are provided below.

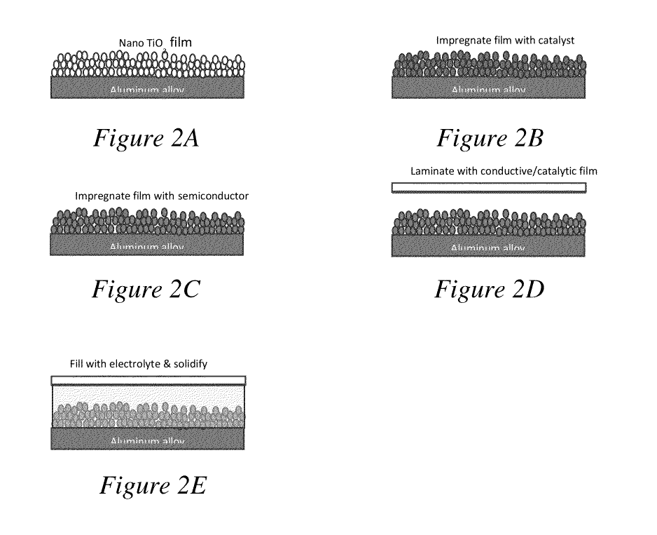

A method of manufacturing a preferred solar cell embodiment will now be described with respect to FIGS. 2A through 2E. In other embodiments, the titanium dioxide particles are impregnated prior to coating the substrate. In other embodiments, a one step coating process involving both anode and electrolyte is performed. In another embodiment, the aluminum alloy (with a catalyst coating) may act as the cathode or cathode current collector, and the transparent conductive barrier film can be coated with the anode film and act as the anode current collector.

Referring now to FIG. 2A, a nano titanium oxide paste is prepared and applied to the aluminum alloy substrate to form a film. The nano titanium oxide paste is typically composed of one or more types/sizes of TiO₂ nanoparticles, such as Evonik P25. Other ingredients can include binder, thickener, pore former (0-20 wt %), surfactants (0-2%), and acid or base for pH/rheology control-typically mineral acids are used but organic acids are bases also can be effective. The solvent can be deionized water or alcohols such as ethanol, isopropanol or ethylene glycol. The weight percent solids can vary from 10-45% depending on the paste formulation. Properties that can affect the outcome of this step include viscosity, surface tension, particle size distribution and percent solids. Nano TiO₂ films are typically 2-15 microns thick.

The film may be applied using a variety of methods as long as a thin, uniform coating is produced. Examples of application processes include spraying, doctor blading, tape casting, and ink jet printing.

After coating and drying, the film may be sintered at 300-550° C. for 15-30 minutes in order to improve mechanical strength and adhesion. It may be sintered under vacuum or in an inert atmosphere (nitrogen or argon) in order to reduce surface oxidation of the aluminum alloy.

Referring now to FIG. 2B, the titanium oxide film is impregnated with a catalyst at room temperature. This catalyst can be comprised of the following metals alone or in combinations: Pt, Pd, Rh, Au, or Ag. The metals salts can be chlorides, nitrates, acetates, or organometallic alkoxides can be used, and solutions are 0.001-0.1% w/percent on a metals basis. The solvent may be deionized water or an alcohol. 1-10 wt % glacial acetic acid may be added as a buffer to control the amount of metal fixed to the titanium oxide. The metal salt are electrostatically fixed at temperatures between room temperature and 100° C., and can be reduced by heating to 120-190° C., in the presence of an added reducing agent, if necessary (depending on the solvent chosen). The reduction step may be followed by a rinsing step(s) using a solvent such as alcohol, acetone and/or water. Rinsing can be followed by a drying step (75-125° C.) and possibly a firing step (300-550° C.). As an alternative reduction process, after the room temperature impregnation step, the film can be immediately rinsed, dried and then thermally reduced at (400-550° C.) under nitrogen, argon or vacuum. The catalyst will form well-dispersed nanoparticles on the TiO₂ surface.

Referring now to FIG. 2C, the film is then coated with a semiconductor by impregnating with a solution (typically a chloride, nitrate or acetate). The semiconductor layer is 2-10 nm thick, is bound the underlayers, and is comprised of nanoparticles. The solvent may be deionized water or an alcohol. The metal salt complex is electrostatically fixed at temperatures between room temperature and 100° C. The metal salts can be decomposed by heating to 120-190° C., in the presence of an added reducing agent, if necessary (depending on the solvent chosen), followed by a rinsing step using a solvent such as alcohol, acetone and/or water, followed by a drying step (75-125° C.) and possibly a firing step (300-550° C.). An alternative process is, after the room temperature impregnation step, the film can be immediately rinsed, dried and then thermally fired at (400-550° C.).

Construction of the cell is then performed. A thermoplastic or cross linkable polymer is typically applied, forming walls around the active area.

Referring next to FIG. 2E, the encasement is then filled with electrolyte polymer, using a syringe or pipette. This process is repeated as necessary to achieve the desired fill level.

Referring now to FIG. 2D, the electrolyte layer is then covered by a catalyzed commercial transparent conducting film. The entire device is then laminated with a barrier film layer, using either roll lamination or preferably vacuum lamination.

Further details on methods and devices for cooling tissue, including methods and devices which can be used in conjunction with those described herein, are discussed in the documents cited herein, which are each hereby incorporated by reference herein in their entirety.

The foregoing description has been presented for purposes of illustration and description. Many modifications and variations of the subject matter described will be apparent to those skilled in the art. Although the invention has been described by reference to specific embodiments, it should be understood that numerous changes can be made within the spirit and scope of the inventive concepts described. Accordingly, it is intended that the invention not be limited to the described embodiments, but that it have the full scope defined by the language of the following claims.

The following table provides citations for the noted numbers provided above:
1. McKinsey and Co., “Myths and realities of clean technologies” April 2014
2. Int. Bus. Times “China Solar Panel: The Barely Revived Industry Could Be Heading For Another Bust” Jan. 27, 2014
3. Acc. Chem. Res., 2012, 45 (5), pp 705-713
4. J. Phys. Chem. Lett., 2010, 1 (20), pp 3046-3052
5. Nature, Scientific Reports 10 Jan 2013, (3) pp 1-8
6. Langmuir, 2014 30 (25) pp7264-7273
7. Plat. Metals. Rev. 1976 20 (2) 48-52
8. Nanoscale Res. Lett. 2011 6 (426) pp 2-4.
9. Chem. Phys. Phys. Chem. 2014 15 (10) 2094-2107
10. Solar Energy Materials and Solar Cells 2003 77
11. Appl. Phys. Express. 2011 4 (6) 062301
12. Appl. Phys. Lett. 2006 88 163502
13. Chem. Phys. Lett., 2008 463, 117-12011
14. Nature, 1991 (353) 737-739
15. J. Photochem. Photobio. A: Chem. 2004 164 (1-3) 3-14
16. Chem. Rev. 2010 110 (11) 6595-6663
17. Phys. Rev. Lett. 110, 078701 (2013)
18. “Study of Thin Film Solar Cell based on Copper Oxide Substrate by DC Reactive Magnetron Sputtering” Oleksiyi Lytovchenko, Universita Degli Studi di Padova and Istituto Nazionale Di Fisica Nucleare. Master's Thesis 2008-09.
19. Energy Environ. Sci, 2012, 5 9394-9405

What is claimed is:

1. A solar cell, comprising:
a substrate;
a transparent barrier film;
an anode disposed between the substrate and the transparent barrier film, the anode comprising a film of oxide nanoparticles having first and second coating layers, wherein one of the first and second coating layers is a catalyst nanoparticle coating layer and a second one of the first and second coating layers is a metal oxide photoactive semiconductor coating layer; and
a cathode.

2. The solar cell of claim 1, wherein the substrate comprises an aluminum alloy that forms part of the anode.

3. The solar cell of claim 1, wherein the film of oxide nanoparticles is formed of titanium oxide.

4. The solar cell of claim 3, wherein the metal oxide photoactive semiconductor coating layer is formed from a material having have a conduction band edge below −4.21 eV and a band energy gap less than 2 eV.

5. The solar cell of claim 4, wherein the metal oxide photoactive semiconductor coating layer is formed from cupric oxide.

6. The solar cell of claim 4, wherein the metal oxide photoactive semiconductor coating layer is formed from hematite.

7. The solar cell of claim 1, wherein the catalyst nanoparticle coating layer is formed from platinum.

8. The solar cell of claim 1, wherein the catalyst nanoparticle coating layer is formed from palladium.

9. The solar cell of claim 1, wherein the transparent barrier film is conductive and forms the cathode.

10. The solar cell of claim 9, wherein the transparent barrier film is a three layer transparent conductive barrier film comprising a catalyst layer which acts as a cathode, a transparent conducting oxide, which acts as part of the cathode, and a transparent barrier film layer.

11. The solar cell of claim 1, further comprising an electrolyte provided between the anode and the cathode.

12. The solar cell of claim 9, further comprising an electrolyte provided between the anode and the cathode.

13. A solar cell comprising:
a substrate;
a transparent barrier film;
a first electrode at least partially disposed between the substrate and the barrier film, the first electrode being formed of titanium oxide nanoparticles having first and second coating layers, a first one of the first and second coating layers comprising platinum catalyst nanoparticles and a second one of the first and second coating layers comprising a metal oxide photoactive semiconductor; and
a second electrode disposed at least partially between the substrate and the transparent barrier film.

14. The solar cell of claim 13, wherein the first electrode is an anode.

15. The solar cell of claim 13, wherein the first electrode is a cathode.

16. The solar cell of claim 13, wherein the second electrode is formed of titanium oxide nanoparticles having first and second coating layers, a first one of the first and second coating layers comprising platinum catalyst nanoparticles and a second one of the first and second coating layers comprising a metal oxide photoactive semiconductor.

17. The solar cell of claim 13, wherein the substrate is part of the first or the second electrode.

18. A method for forming an electrode having a core and two layers, the electrode for use in a solar cell, comprising:
providing a titanium oxide nanoparticle substrate;
providing a catalyst layer on the titanium oxide nanoparticle substrate, providing the catalyst layer comprising:
impregnating a metal salt onto the titanium oxide nanoparticle substrate in an aqueous or alcohol solvent;
fixing the metal salt to the surface of the titanium oxide nanoparticle substrate by heating; and
chemically reducing the metal salt to a desired metal or metal oxide; and
providing a photoactive metal oxide layer on the titanium oxide nanoparticle substrate, providing the photoactive metal oxide layer comprising:
impregnating a metal salt onto the titanium oxide nanoparticle substrate in an aqueous or alcohol solvent;
fixing the metal salt to the surface of the titanium oxide nanoparticle substrate by heating; and
chemically reducing the metal salt to a desired metal oxide.
